(19) United States
(12) Patent Application Publication
(10) Pub. No.: US 2013/0080429 A1
(43) Pub. Date: Mar. 28, 2013

(54) ENTERPRISE SYSTEM AND CANDIDATE RETRIEVAL

(71) Applicant: GEORGE BOSH, Pacifica, CA (US)

(72) Inventor: GEORGE BOSH, Pacifica, CA (US)

(21) Appl. No.: 13/486,666

(22) Filed: Jun. 1, 2012

Related U.S. Application Data
(60) Provisional application No. 61/538,522, filed on Sep. 23, 2011.

(51) Int. Cl. G06F 17/30

(52) U.S. Cl. 707/732; 707/E17.082

(57) ABSTRACT

A system of project management and data retrieval in an enterprise system may employ searches based on probabilistic indexing to retrieve potential candidates. The results of probabilistic indexing may provide one or more candidates that correspond to query criteria.

### CROSS-REFERENCE TO RELATED APPLICATION

This application claims benefit under 35 U.S.C. §119(e) of U.S. Provisional Application No. 61/538,522 filed Sep. 23, 2011, which is hereby incorporated by reference herein in its entirety.

### BACKGROUND OF THE INVENTION

The present invention generally relates to program management, and more particularly to an enterprise software system.

In companies, and typically in enterprise scale ventures, routine business activities can be hampered by the size of the enterprise and the bureaucracy implemented for managing activities. Efficiency in the use of talent and resources may suffer as a consequence. For example, some enterprises may span across international borders. Barriers, such as language differences and lack of communication between departments of different physical locations hamper the ability to use personnel efficiently. The result may be drawing from the locally available talent pool. This may lead to ineffective personnel being placed in positions that may be better suited for other individuals for the overall effectiveness of the enterprise. The talent pool available for projects at a particular locale may be insufficient however better suited candidates may be available from distant sources. In large part this can be traced to the lack of a practical, generic bureaucratic theory for structuring large work-producing organizations.

There exists a general need to address the inherent limitations of a military command and control structure for large scale work-producing organization by adapting it to a practical bureaucratic theory (Requisite Organization), incorporating the elements of workflow, financial oversight, and probabilistic indexing for people and documents.

### SUMMARY OF THE INVENTION

In one aspect of the present invention, a computer program product for retrieving data within an enterprise system, the computer program product comprising a computer readable storage medium having computer readable program code embodied therewith, the computer readable program code being configured to display a data entry form including fields related to project management; retrieve from one or more databases within the enterprise system, candidates that correspond to filled out fields in the data form, the retrieval based on results of those candidates to solicit information for the probabilistic search engine, (KNOW).

In another aspect of the present invention, a system of project management within an enterprise comprises an organization development system configured to provide structures for personnel hierarchies; a set of project management tools to track project costs and personnel responsibilities in projects; and linkage to a probabilistic search engine for tracking personnel based on their responsibilities in projects or their function within the organization and a probabilistic search engine.

These and other features, aspects and advantages of the present invention will become better understood with reference to the following drawings, description and claims.

### BRIEF DESCRIPTION OF THE DRAWINGS

FIG. 1 is a schematic overview of an enterprise system according to an exemplary embodiment of the present invention;

FIG. 2A is a schematic view of an integrated organization development system implemented with the enterprise system of FIG. 1;

FIG. 2B is a schematic view of project management tools integrated within the enterprise system of FIG. 1;

FIG. 2C is a schematic view of financial oversight tools and a probabilistic search engine integrated within the enterprise system of FIG. 1;

FIG. 3 is a block diagram of a program organization that uses the enterprise system of FIG. 1;

FIG. 4 is a screenshot of a data entry form that subsumes the whole of a bureaucratic theory for a work-producing organization while integrating work-flow and financial oversight within the enterprise system of FIG. 1. This form also links to a probabilistic search engine for people and documents of FIG. 1; and

FIG. 5 is a screenshot of a worker input sheet for the probabilistic search engine used to collect project information within the enterprise system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides an enterprise system for program management. In an exemplary embodiment, the system may be implemented in computer readable media. The system may bring together and integrate a plurality of software tools or processes.

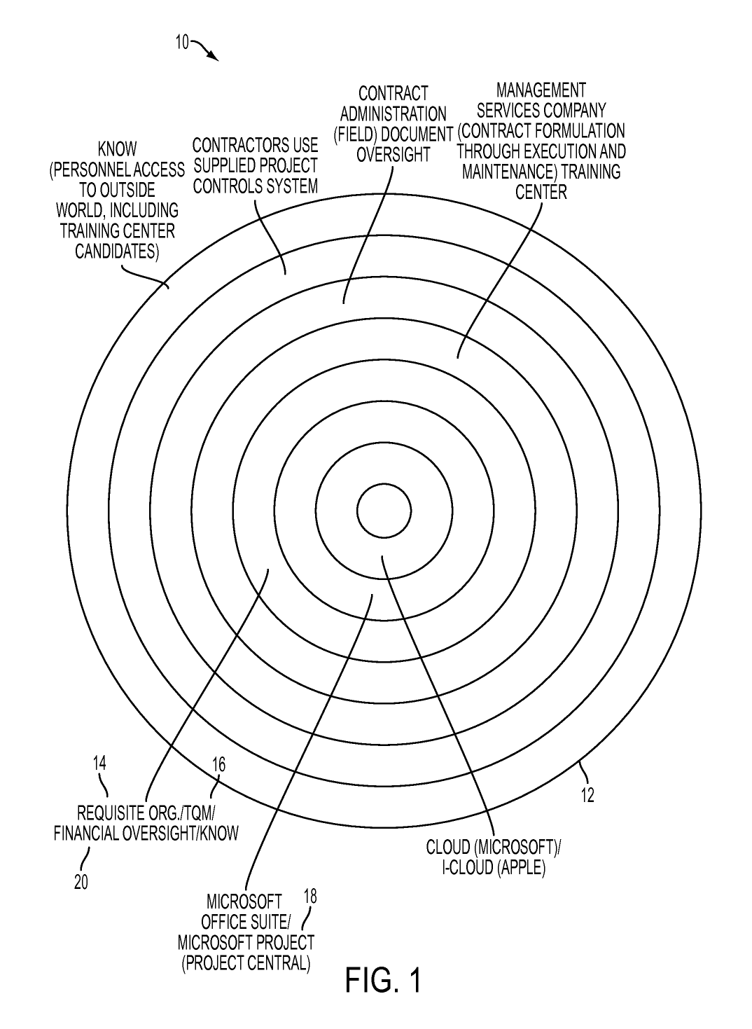

Referring now to FIG. 1, a schematic overview of an enterprise software system (ESS) 10 is shown according to an exemplary embodiment of the present invention. The ESS 10 may include a probabilistic indexing system 12 for tracking documents and people. The probabilistic indexing system is labeled as KnowledgeNet OneWorld (KNOW). An organization development system 14 (labeled “Requisite Organization”) (sometimes called the requisite organizational scheme 14) may provide a structure with specific layers that may be required for specific managerial hierarchies. Techniques offered by the “Requisite Organization may outline which functions should be performed at each level of the system 10 and which managers should be accountable for which employees and for the satisfactory result of designated work. A Total Quality Management (TQM) function 16 may be integrated with the organization development system 14 and may provide for continuous improvement in quality of products and processes. In the TQM function 16 all members of an organization may participate in improving processes, products, services and the culture in which they work. A set of comprehensive project management tools 18, for example, MS Project® along with MS Office suite® may be provided through Cloud or iCloud technologies. An enterprise financial management tool 20, for example, a tool from SAP AG® may be provided for financial planning and oversight.

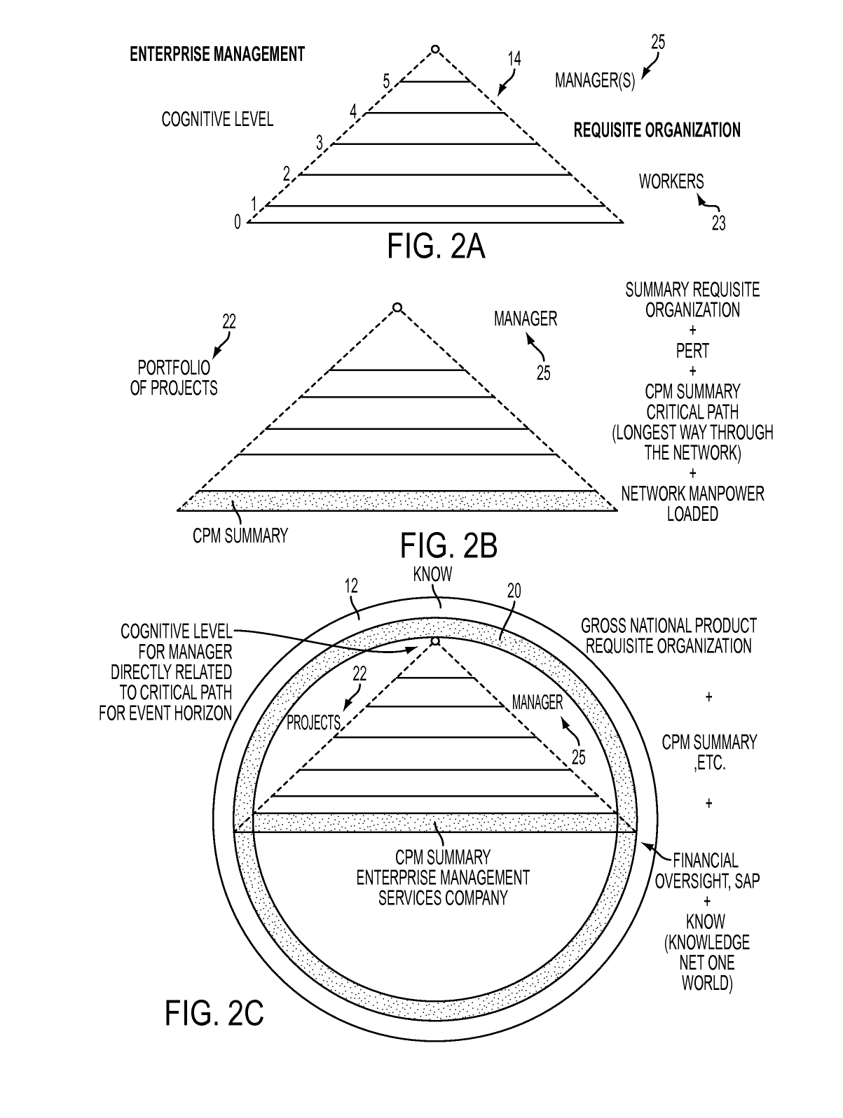

Referring now to FIGS. 2A-2C, exemplary organizational hierarchical schemes to implement the ESS 10 are shown as they may be used in an enterprise unit (not shown). FIG. 2A shows the organization development system 14 (Requisite Organization) integration into the ESS 10. The ESS 10 may refer to the organization development system 14 hierarchy when associating the responsibilities of a position to the cognitive level that should be requisite for the level of responsibility for the position being filled. In the integrated ESS 10 there may exist a separation between a manager 25 and a knowledge worker 23 by cognitive levels and responsibilities. Managers 25 may be closer to the top of the hierarchy while the various levels of skilled and semi-skilled workers 23 may fill the lower levels. For example, the manager 25 may be responsible for quality, timeframe, and budgetary issues, generally for a satisfactory result of the work effort. Workers 23 may provide skills to implement the completion of the designated work effort.

FIG. 2B may represent the levels of responsibility corresponding to a portfolio of projects 22 (or sub-projects). Each project 22 may be handled by its own manager 25. The levels of project responsibility under the manager 25 may be filled by subordinate managers 25 and workers 23. A manager 25 may use the project management tools 18 to administrate projects 22. Documents related to the projects 22 may be stored in a database (not shown). The project management tools 18 may meld a project performance and review technique (PERT), or critical path method for planning and scheduling (CPM) with the requisite organizational scheme 14. The project management tools may show manpower-loadings, time-scaled CPM network summary schedules, and critical paths. The length of the critical path may be determined based on the cognitive level by a manager 25 in charge. The cognitive level of the manager 25 in charge may be based on the length of the critical path.

FIG. 2C shows the enterprise financial management tools 20 integration within the ESS 10. The financial management tools 20 along with the requisite organization scheme 14 and the probabilistic indexing system 12 (KNOW) may be used to oversee the completion of projects 22 by a manager 25.

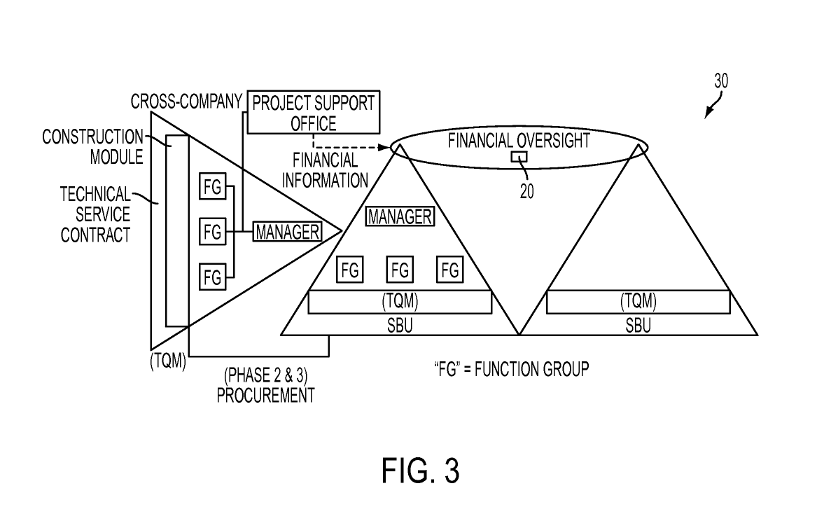

FIG. 3 shows a project process 30 diagram according to another exemplary embodiment of the ESS 10. The project process 30 may include essential elements of a management service company (MSC) (not shown), for example, the indexing system 12, (KNOW) (FIG. 1), the financial management tools 20 for financial oversight, and PERT (not shown). The project process 30 shown by FIG. 3 may be applicable to support, for example, an oil recovery process. However, modified versions of the process may be well suited for management of industrial infrastructure (“Nation Building”), covering contract formulation, execution, operation, and maintenance. The MSC will accommodate these and other work process flows, such as a De Soto process for the recovery of dead capital and bringing it to market.

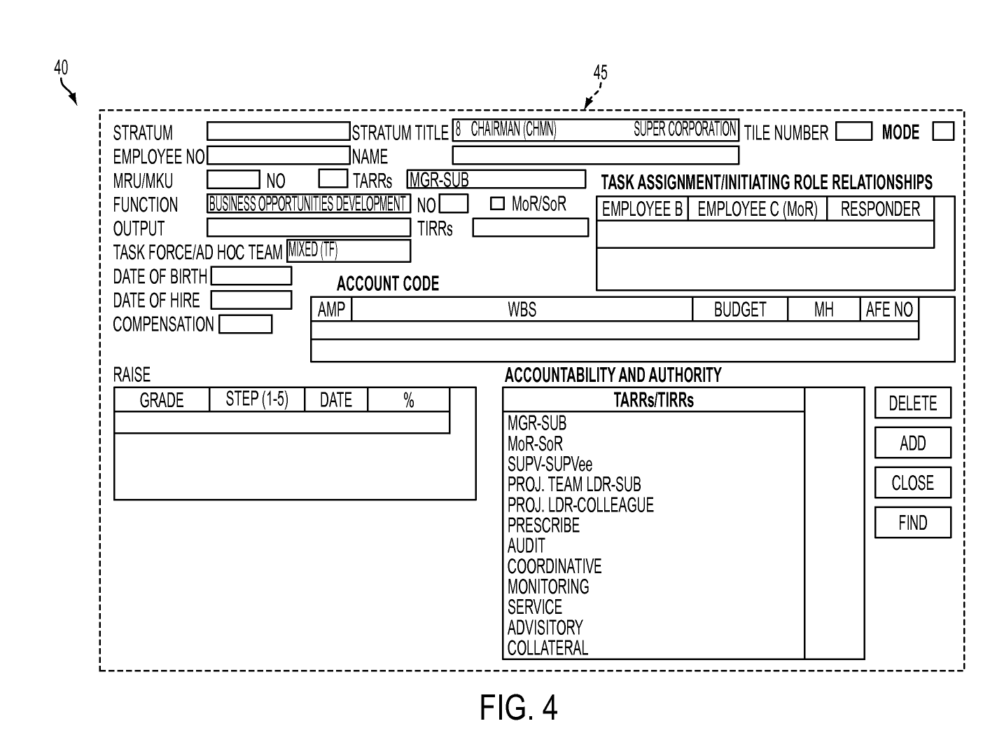

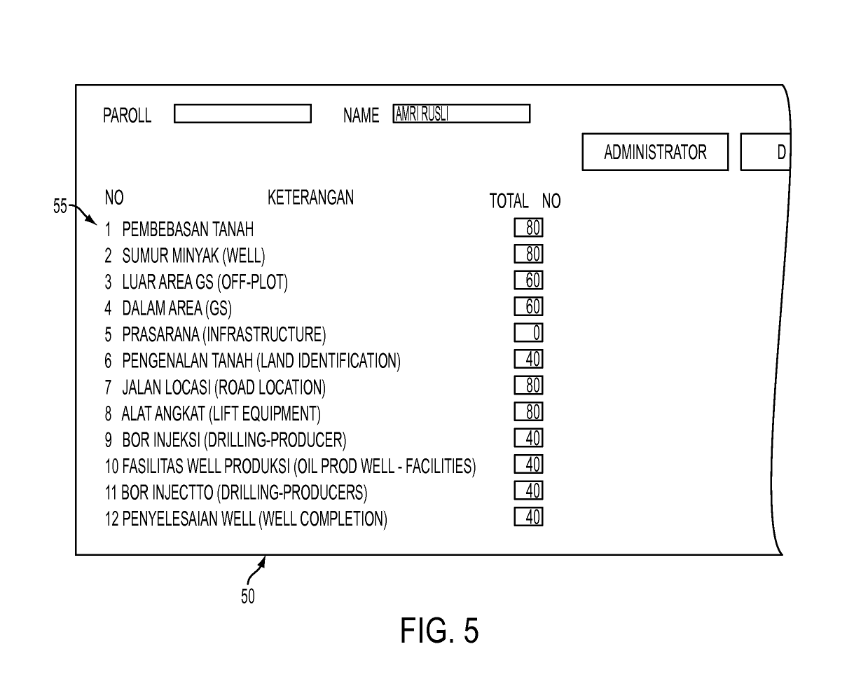

FIG. 4 shows a screenshot 40 of a data entry form 45 used for organization, project workflow, and financial oversight. The form 45 may provide a dashboard for user interface. The form 45 may be linked to (KNOW) (FIG. 1), a Document form (not shown), and an Employee Data Entry form (FIG. 5.). The data input into the form 45 may be used by the requisite organizational scheme 14 for probabilistic indexing and retrieval of candidate personnel, documents, and other resources. The requisite organizational scheme 14 may navigate within the system's infrastructure, for example, databases (not shown). The databases may be within different geographical boundaries; for example, in different countries. Information access to system information may, in one embodiment, be performed through the World Wide Web. For example, a manager 25 may interface the requisite organizational scheme 14 using the data entry form 45 and may wish to locate candidate personnel (workers 23) that may be needed for a project 22. The manager 25 may input into the form 45 criteria such as a skill, a pay grade, a job title, etc. The form 45 may treat the filled out fields as queries and may retrieve based on probabilistic indexing, candidates along with their corresponding biographical data. The retrieved candidates may be based on those candidates meeting threshold levels within the probabilistic indexing. The manager 25 may be able to specify the threshold indexing level returned. For example, those candidates meeting at least 65% probability or corresponding to the query may be retrieved. The retrieved data may be shown in the manager's native language. The retrieved data may be shown on the interface displaying the form 45.

For contract oversight, a contractor administrator may assign a probability from 1 to 10, to each document passing through his desk. This document assignment may be used to establish a database. The database(s) may be available to select people based on their cognitive level in the ESS 10 (for example, managers 25) who might be able to update and use it for job progress oversight. For the personnel applications, workers 23 might fill out a data entry form 45 online.

FIG. 5 is a screenshot of a worker input sheet 50. The data fields 55 may be in the worker's native language. In an exemplary embodiment, data fields 55 may include a translated copy of the respective fields 55. The fields 55 may be translated into the native language of either the person accessing the document via search or into the native language of the worker 23 who is in a foreign country.

Any combination of one or more computer readable medium(s) may be utilized for interfacing with the data entry form 45 and accessing the information retrieved through probabilistic indexing. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It should be understood, of course, that the foregoing relates to exemplary embodiments of the invention and that modifications may be made without departing from the spirit and scope of the invention as set forth in the following claims.

What is claimed is:

1. A computer program product for retrieving data within an enterprise system, the computer program product comprising a computer readable storage medium having computer readable program code embodied therewith, the computer readable program code being configured to:
display a data entry form including fields related to project management;
retrieve from one or more databases within the enterprise system, candidates that correspond to filled out fields in the data entry form, the retrieval based on results of those candidates corresponding to a threshold of probabilistic indexing; and
display the retrieved candidates.

2. The computer program product of claim 1, the computer readable program code being configured to access the one or more databases between different countries.

3. The computer program product of claim 1, the computer readable program code being configured to display the retrieved candidates in a user's native language.

4. The computer program product of claim 1, wherein the candidates are personnel.

5. The computer program product of claim 1, wherein the candidates are documents.

6. A system of project management within an enterprise, comprising:
an organization development system configured to provide structures for personnel hierarchies;
a set of project management tools to track personnel responsibilities in projects; and
a probabilistic indexing system for tracking personnel based on their responsibilities in projects.

7. The system of claim 6, wherein the probabilistic indexing system tracks documents related to the projects.

8. The system of claim 6, wherein access to the probabilistic indexing system is based on a cognitive level corresponding to the personnel responsibilities.
